(19) United States
(12) Patent Application Publication
(10) Pub. No.: US 2011/0286199 A1
(43) Pub. Date: Nov. 24, 2011

(54) Apparatus For An Electronic Device

(75) Inventors: Pete Miikkola, Oulu (FI); Vitali Samurov, Tampere (FI); Antti Wright, Kangasala (FI)

(73) Assignee: NOKIA CORPORATION, Espoo (FI)

(21) Appl. No.: 12/521,555

(22) PCT Filed: Dec. 27, 2006
(86) PCT No.: PCT/IB2006/004108

§ 371 Date: Dec. 5, 2010

(51) Int. Cl. G03B 15/06; F21V 14/00

(52) U.S. Cl. 362/7; 362/280; 362/18

(57) ABSTRACT

An apparatus for an electronic device, the apparatus comprising a light-output region and a movable part, the movable part comprising an optical element and being movable between an open configuration and a closed configuration with respect to the light-output region; wherein the apparatus is arranged such that, in the closed configuration, the optical element at least partially overlies the light-output region and, in the open configuration, the optical element overlies the light-output region to a lesser extent than in the closed configuration, and wherein the optical element is arranged to alter a pattern of light emitted from the light-output region such that the light is emitted in a first light output pattern in the open configuration and in a second light output pattern in the closed configuration.

The invention relates to an apparatus for an electronic device, a method of operating an apparatus for an electronic device, and an electronic device including the apparatus.

### BACKGROUND

An electronic device may include a flash for use with an image sensor or camera device. The flash may also serve as a torchlight.

An electronic device may include a macro lens for use in macro photography, the macro lens being switchable on and off mechanically, being provided on a rotating wheel or being separately attachable to the electronic device. The electronic device may include an autofocus lens, which may have a macro autofocus mode.

The listing or discussion of a prior-published document in this specification should not necessarily be taken as an acknowledgement that the document is part of the state of the art or is common general knowledge.

### SUMMARY

According to a first aspect, there is provided an apparatus for an electronic device, the apparatus comprising
a light-output region and a movable part, the movable part comprising an optical element and being movable between an open configuration and a closed configuration with respect to the light-output region;
wherein the apparatus is arranged such that, in the closed configuration, the optical element at least partially overlies the light-output region and, in the open configuration, the optical element overlies the light-output region to a lesser extent than in the closed configuration, and wherein the optical element is arranged to alter a pattern of light emitted from the light-output region such that the light is emitted in a first light output pattern in the open configuration and in a second light output pattern in the closed configuration.

The optical element may completely overlie the light-output region in the closed configuration. The optical element may lie in an offset arrangement with the light-output region in the open configuration such that the optical element does not overly the light-output region in the open configuration.

The optical element may be a lens.

The movable part may comprise a protection glass and/or lens cover, for example.

The apparatus may comprise a light-output element for an image sensor, and the apparatus may be arranged such that the light-output element can emit light from the light-output region when the light-output element is activated to emit light. The light-output element may comprise a flash, such as an LED FLASH or a xenon flash, and/or a video auxiliary light, for example. The image sensor may comprise a digital image sensor, such as a charge-coupled device (CCD), a complementary metal oxide semiconductor (CMOS) sensor, and/or an active pixel sensor, and/or an apparatus arranged to capture images on photographic film, for example.

The apparatus may be arranged such that when the apparatus is in the open configuration, the light-output element is arranged to act as a flash for image capture by the image sensor.

The first optical element may be arranged to adapt the pattern of light emitted from the light-output region for use (e.g. of the light-output element) as a torch (e.g. in the closed configuration).

The first optical element may be arranged to adapt the pattern of light emitted from the light-output region for use (e.g. of the light-output element) as a reading lamp (e.g. in the closed configuration). The apparatus may incorporate an adjustable support frame allowing the orientation of the apparatus relative to a base of the frame to be adjusted.

The optical element may be arranged to adapt the pattern of light emitted from the light-output region for use in macro photography in the closed configuration.

The apparatus may comprise a light-input region for an image sensor, and the apparatus may be arranged such that the movable part at least partially reveals the light-input region in the open configuration and at least partially overlies the light-input region in the closed configuration.

The apparatus may comprise a light-input region for an image sensor, the apparatus may be arranged such that the movable part completely reveals the light-input region in the open configuration and completely overlies the light-input region in the closed configuration.

The apparatus may comprise a lens positioned within the light-input region and/or arranged to receive light passing through the light-input region. The lens may be arranged to focus light onto the image sensor.

The apparatus may be arranged such that a beam width of the second light output pattern is narrower than a beam width of the first light output pattern.

The apparatus may comprise a light-input region for an image sensor, and the movable part may comprise a second optical element arranged such that it lies in an offset arrangement with the light-input region in the open configuration and at least partially overlies the light-input region in the closed configuration.

The apparatus may comprise a light-input region for an image sensor, and the movable part may comprise a second optical element arranged such that it lies in an offset arrangement with the light-input region in the open configuration and completely overlies the light-input region in the closed configuration.

The optical element may surround the second optical element and may be arranged to diffuse light emitted by the light-output element.

The first optical element may be arranged to act as a ring flash.

The first optical element may comprise a neutral density (ND) material.

The second optical element may comprise a macro lens.

The apparatus may comprise dark matter positioned between the optical element and the second optical element to prevent flare in an image captured by the image sensor.

The apparatus may comprise a light-output element for an image sensor, the light-output element being arranged to emit light from the light-output region, wherein the first optical element is arranged to adapt the pattern of light emitted from the light-output region for use of the light-output element in macro photography.

The apparatus may comprise circuitry arranged to control an intensity of the light emitted by the light-output element. This control may be based on the configuration of the apparatus.

According to a second aspect, there is provided an electronic device including the apparatus of the first aspect. The electronic device may comprise a mobile phone, a digital or non-digital camera, a personal computer and/or a personal digital assistant, for example.

According to a third aspect, there is provided a method of operating an apparatus for an electronic device, the apparatus comprising a light-output region and a movable part, the movable part comprising an optical element and being movable between an open configuration and a closed configuration with respect to the light-output region;
wherein the apparatus is arranged such that, in the closed configuration, the optical element at least partially overlies the light-output region and, in the open configuration, the optical element overlies the light-output region to a lesser extent than in the closed configuration, the method comprising
moving the movable part to cause the optical element to alter a pattern of light emitting from the light-output region such that the light is emitted in a first light output pattern in the open configuration and in a second light output pattern in the closed configuration.

According to a fourth aspect, there is provided an apparatus for an electronic device, the apparatus comprising
means for allowing light output and means for moving between configurations, the means for moving between configurations comprising means for altering a light-output pattern and being movable between an open configuration and a closed configuration with respect to means for allowing light output;
wherein the apparatus is arranged such that, in the closed configuration, the means for altering a light-output pattern at least partially overlies the means for allowing light output and, in the open configuration, the means for altering a light-output pattern overlies the means for allowing light output to a lesser extent than in the closed configuration,
and wherein the means for altering a light-output pattern is arranged to alter a pattern of light emitted from the means for allowing light output such that the light is emitted in a first light output pattern in the open configuration and in a second light output pattern in the closed configuration.

According to a fifth aspect, there is provided a method of operating an apparatus for an electronic device, the apparatus comprising a means for allowing light output and means for moving between configurations, the means for moving between configurations comprising means for altering a light-output pattern and being movable between an open configuration and a closed configuration with respect to the means for allowing light output;
wherein the apparatus is arranged such that, in the closed configuration, the means for altering a light-output pattern at least partially overlies the means for allowing light output and, in the open configuration, the means for altering a light-output pattern overlies the means for allowing light output to a lesser extent than in the closed configuration, the method comprising
a step for moving the means for moving between configurations to cause the means for altering a light-output pattern to alter a pattern of light emitting from the means for allowing light output such that the light is emitted in a first light output pattern in the open configuration and in a second light output pattern in the closed configuration.

The present invention includes one or more aspects, embodiments or features in isolation or in various combinations whether or not specifically stated (including claimed) in that combination or in isolation.

The above summary is intended to be merely exemplary and non-limiting.

### BRIEF DESCRIPTION OF THE DRAWINGS

A description is now given, by way of example only, with reference to the accompanying drawings, in which:

FIG. 1 shows a first apparatus in an open configuration;

FIG. 2 shows the apparatus of FIG. 1 in a closed configuration;

FIG. 3 is a schematic diagram of the apparatus of FIG. 1;

FIG. 4 shows a second apparatus in an open configuration;

FIG. 5 is an enlarged view of part of FIG. 4 showing further detail;

FIG. 6 shows the apparatus of FIG. 4 in a′ closed configuration;

FIG. 7 is a schematic diagram of the apparatus of FIG. 4;

FIG. 8 is a flowchart representing a method of operating an apparatus;

FIG. 9 shows a third apparatus and light-output patterns of the third

FIG. 10 is a front view of the third apparatus of FIG. 9;

FIG. 11 shows light-output patterns of the first apparatus of FIG. 1;

FIG. 12 shows a fourth apparatus and light-output patterns of the fourth apparatus;

FIG. 13 shows a fifth apparatus in a first configuration;

FIG. 14 shows the apparatus of FIG. 13 in a second configuration;

FIG. 15 shows the apparatus of FIG. 13 in a third configuration.

### DETAILED DESCRIPTION

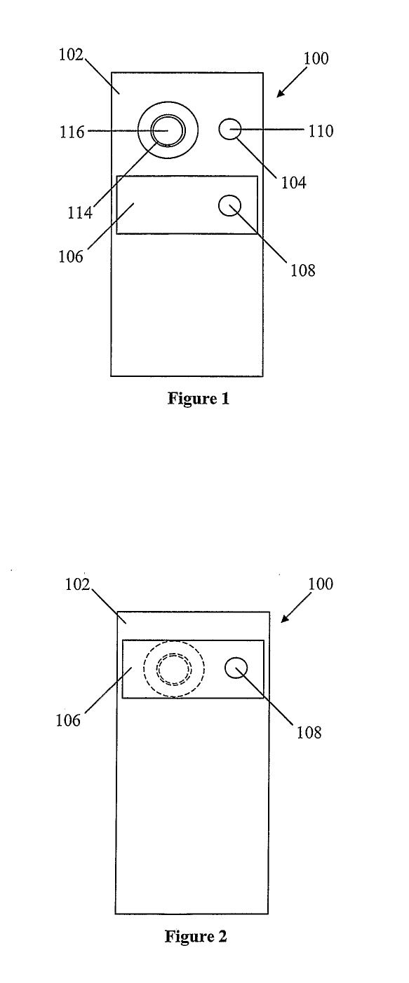

FIGS. 1 to 3 show a first apparatus 100 for an electronic device. The apparatus 100 comprises a housing 102 having a light-output region 104 and a movable part 106. The movable part 106 is (e.g. slidably) movable between an open configuration, shown in FIG. 1, and a closed configuration, shown in FIG. 2. In one embodiment, the movable part 106 comprises a protection glass. In another embodiment, the movable part 106 comprises a lens cover.

The movable part 106 comprises a first optical element 108, which in one embodiment is a lens. The apparatus 100 is, arranged such that the first optical element 108 overlies the light-output region 104 in the closed configuration, and such that the first optical element 108 lies in an offset arrangement with the light-output region 104 in the open configuration.

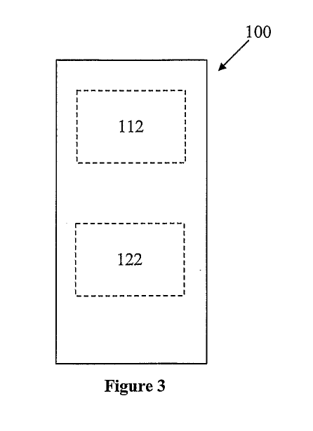

The apparatus 100 comprises a light-output element 110 for an image sensor 112 (shown in FIG. 3), the light-output element 110 being arranged to emit light from the light-output region 104. In one embodiment, the light-output element 110 comprises a flash, such as an LED flash or a xenon flash. In another embodiment, the light-output element 110 comprises a video auxiliary light. The image sensor 112 may comprise a digital image sensor, such as a charge-coupled device (CCD), a complementary metal oxide semiconductor (CMOS) sensor, and/or an active pixel sensor, and/or an apparatus arranged to capture images on photographic film, for example.

The first optical element 108 is arranged to alter a pattern of light emitting from the light-output region 104 such that the light is emitted in a first light output pattern in the open configuration and in a second light output pattern in the closed configuration. In one embodiment, the first optical element 108 is arranged to adapt the pattern of light emitted from the light-output region 104 for use of the light-output element 110 as a torch. In another embodiment, the first optical element 108 is arranged to adapt the pattern of light emitted from the light-output region 104 for use of the light-output element 110 as a reading lamp. In this embodiment, the apparatus 100 incorporates an adjustable support frame (not shown) allowing the orientation of the apparatus 100 relative to a base of the frame to be adjusted. In another embodiment, the apparatus 100 is arranged such that a beam width of the second light output pattern (in the closed configuration) is narrower than a beam width of the first light output pattern (in the open configuration).

The apparatus 100 comprises a light-input region 114 for the image sensor 112, the apparatus 100 being arranged such that the movable part 106 reveals the light-input region 114 in the open configuration and obscures the light-input region 114 in the closed configuration. The apparatus 100 comprises a lens 116 positioned at the light-input region 114 and arranged to receive light travelling towards the light-input region 114. The lens 116 is arranged to focus light onto the image sensor 112.

The apparatus 100 comprises control circuitry 122 (shown in FIG. 3) arranged to control an intensity of the light emitted by the light-output element 110. The circuitry 122 may control one or more other properties of the light emitted by the light-output element 110.

In use, a user moves the position of the movable part 106 according to whether he/she wants to use the apparatus 100 as a camera (in the open configuration) or as a torch/reading lamp (in the closed configuration).

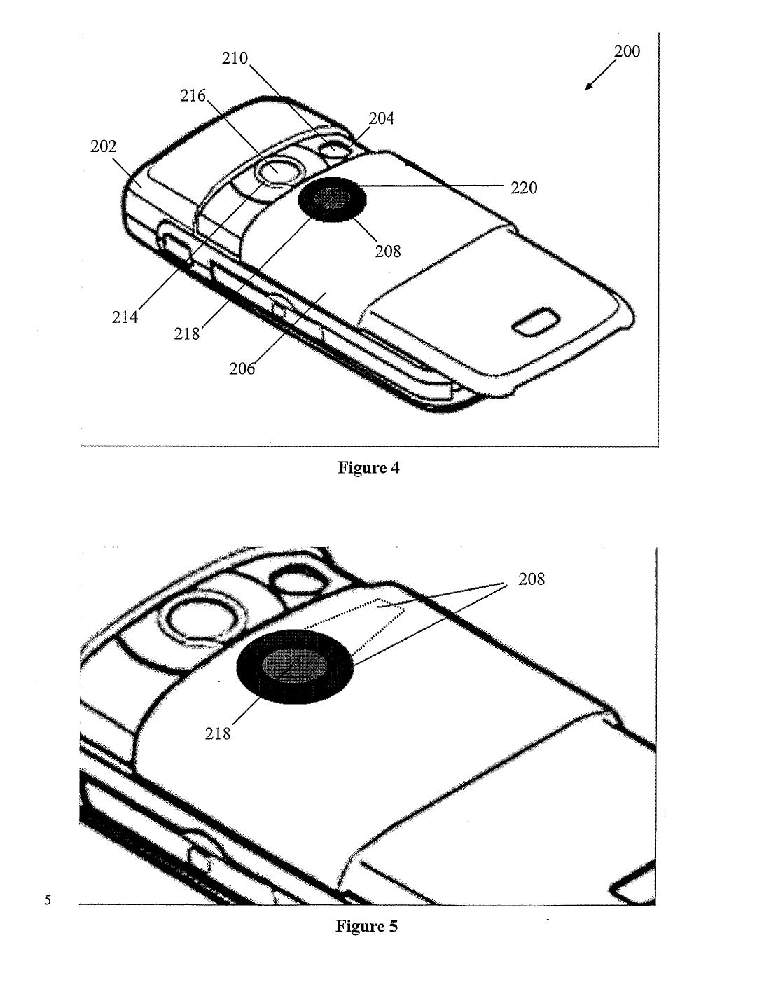

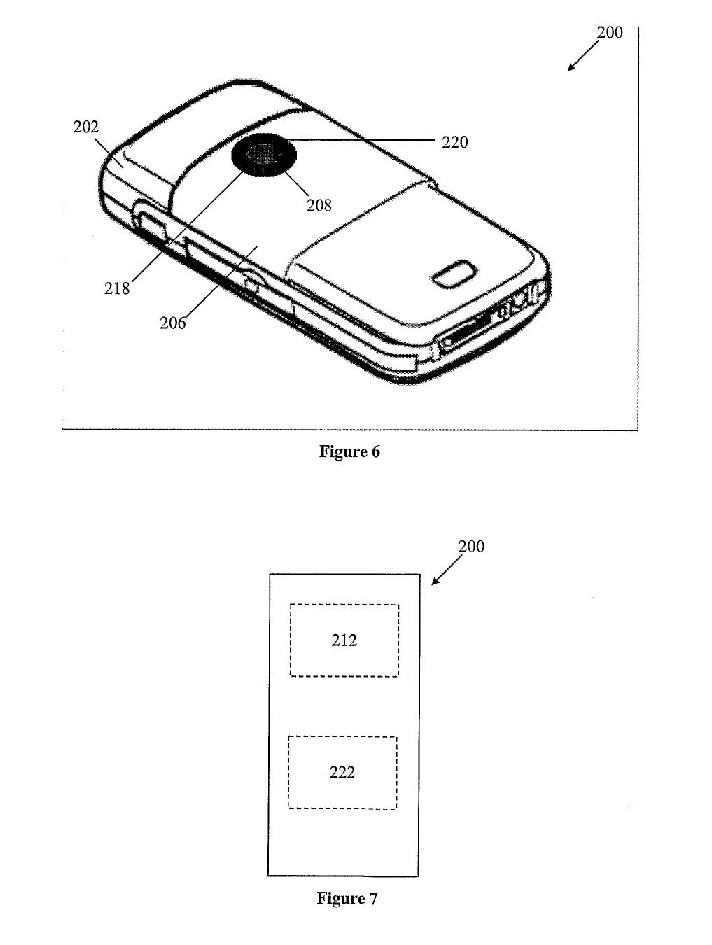

FIGS. 4 to 7 show a second apparatus 200 for an electronic device. The apparatus 200 comprises a housing 202 having a light-output region 204 and a movable part 206. The movable part 206 is movable between an open configuration, shown in FIGS. 4 and 5, and a closed configuration, shown in FIG. 6.

The apparatus 200 comprises a light-output element 210 for an image sensor 212 (shown in FIG. 7), the light-output element 210 being arranged to emit light from the light-output region 204. In one embodiment, the light-output element 210 comprises a flash, such as an LED flash or a xenon flash. In another embodiment, the light-output element 210 comprises a video auxiliary light. The image sensor 212 may comprise a digital image sensor, such as a charge-coupled device (CCD), a complementary metal oxide semiconductor (CMOS) sensor, and/or an active pixel sensor, and/or an apparatus arranged to capture images on photographic film, for example.

The apparatus 200 comprises a light-input region 214 for the image sensor 212. The apparatus 200 comprises a lens 216 positioned at the light-input region 214 and arranged to receive light travelling towards the light-input region 214. The lens 216 is arranged to focus light onto the image sensor 212. The movable part 206 comprises a second optical element 218 arranged such that it lies in an offset arrangement with the light-input region 214 in the open configuration and overlies the light-input region 214 in the closed configuration. In one embodiment, the second optical element 218 comprises a macro lens.

The movable part 206 comprises a first optical element 208. The apparatus 200 is arranged such that (an underside of) the first optical element 208 overlies the light-output region 204 in the closed configuration, and such that (the underside of) the first optical element 208 lies in an offset arrangement with the light-output region 204 in the open configuration. The first optical element 208 is arranged to alter a pattern of light emitting from the light-output region 204 such that the light is emitted in a first light output pattern in the open configuration and in a second light output pattern in the closed configuration. An upperside of the first optical element 208 surrounds the second optical element 218 and is arranged to act as a ring flash in order to diffuse light emitted by the light-output element 210.

As best seen in FIG. 5, light emitted by the light-output element 210 into the underside of the first optical element 208 is guided by the first optical element 208 in a substantially transverse direction relative to the direction in which the light was emitted. The first optical element 208 redirects the light once more in order for it to be emitted from the upperside of the first optical element 208, which surrounds the second optical element 218, in a substantially parallel direction relative to the direction in which the light was emitted from the light-output element 210. The dotted lines in FIG. 5 illustrate the structure of the first optical element 208 within the movable part 206. In one embodiment, the first optical element 208 is arranged to adapt the pattern of light emitted from the light-output region 204 for use of the light-output element 210 in macro photography.

The first optical element 208 comprises a neutral density (ND) material. The ND material may be used to decrease the intensity of the light emitted from the light output region 204.

The apparatus 200 comprises dark matter 220 positioned between the first and second optical elements 208, 218 to prevent flare in an image captured by the image sensor 212.

The apparatus 200 comprises control circuitry 222 (shown in FIG. 7) arranged to control an intensity of the light emitted by the light-output element 210. The circuitry 222 may control one or more other properties of the light emitted by the light-output element 210.

In use, a user moves the position of the movable part 206 according to whether he wants to use the apparatus 200 for macro photography (in the closed configuration) or for non-macro photography (in the open configuration).

The numerals 100, 200 in FIGS. 1 to 7 may also designate an electronic device in which the apparatus 100, 200 is incorporated. In addition to the features of the apparatus 100, 200 described above, the electronic device may incorporate other functionality, for example the functionality of a mobile telephone, other functionality of a digital camera (e.g. image processing), a personal computer, a personal digital assistant, a music player, and/or a game player.

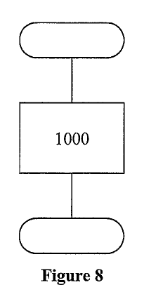

FIG. 8 is a flowchart representing a method of operating an apparatus. The method includes the step (1000) of moving a movable part 106, 206 to cause a first optical element 108, 208 to alter a pattern of light emitting from a light-output region 104, 204 such that the light is emitted in a first light output pattern in an open configuration and in a second light output pattern in a closed configuration.

Although the embodiments described relate to an optical element 108, 208 which slides with respect to the light-output region 104, 204, in other embodiments, the optical element 104, 204 may rotate in and out over the light output region 104, 204. In such embodiments, the movable part may be a rotatable wheel comprising the optical element 104, 204.

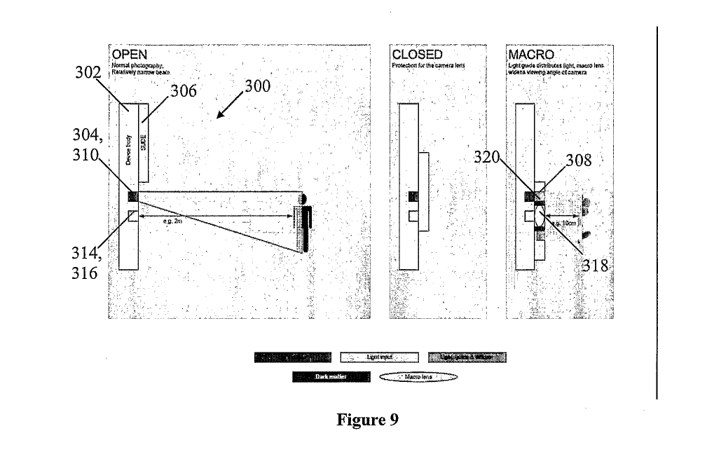

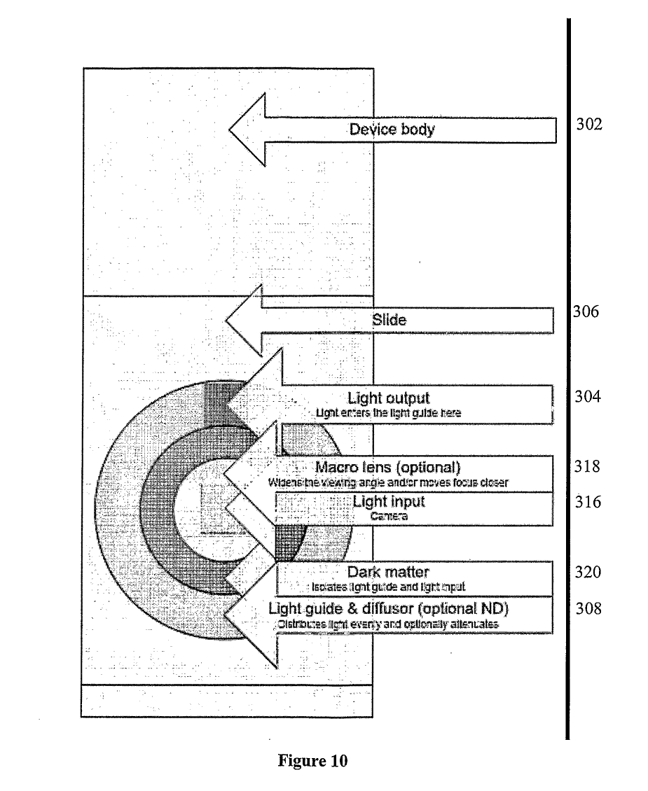

FIGS. 9 and 10 show a third apparatus 300 for an electronic device and light-output patterns of the third apparatus 300. The apparatus 300 comprises a housing 302 having a light-output region 304 and a movable part 306. The movable part 306 is movable between an open configuration, shown in the left-hand image of FIG. 9, a closed configuration, shown in the central image of FIG. 9, and a macro configuration, shown in the right-hand image of FIG. 9.

The apparatus 300 comprises a light-output element 310 for an image sensor (not shown), the light-output element 310 being arranged to emit light from the light-output region 304.

The apparatus 300 comprises a light-input region 314 for the image sensor. The apparatus 300 comprises a lens 316 positioned at the light-input region 314 and arranged to receive light travelling towards the light-input region 314. The lens 316 is arranged to focus light onto the image sensor.

The movable part 306 comprises a first optical element 308. The apparatus 300 is arranged such that (an underside of) the first optical element 308 overlies the light-output region 304 in the macro configuration, and such that (the underside of) the first optical element 308 lies in an offset arrangement with the light-output region 304 in the open configuration. The first optical element 308 is arranged to alter a pattern of light emitting from the light-output region 304 such that the light is emitted in a first light output pattern in the open configuration and in a second light output pattern in the macro configuration. An upperside of the first optical element 308 surrounds the second optical element 318 and is arranged to act as a ring flash in order to diffuse light emitted by the light-output element 310.

The movable part 306 comprises a second optical element 318 arranged such that it lies in an offset arrangement with the light-input region 314 in the open configuration and overlies the light-input region 314 in the macro configuration. In one embodiment, the second optical element 318 comprises a macro lens.

The apparatus 300 comprises dark matter 320 positioned between the first and second optical elements 308, 318 to prevent flare in an image captured by the image sensor.

The first optical element 308 is arranged to adapt the pattern of light emitted from the light-output region 304 for use of the light-output element 310 in macro photography.

As can be seen in the left-hand image of the FIG. 9, the first light-output pattern (in the open configuration) has a narrower beam width than the second light-output pattern shown in the right-hand image of FIG. 9 (in the macro configuration). The first light-output pattern may have roughly the same opening angle as the camera lens 316. The second light-output pattern is diffused relative to the first light-output pattern, and has a wider angle, in order to provide more evenly distributed illumination. The intensity of the second light-output pattern may be lower than that of the first light-output pattern.

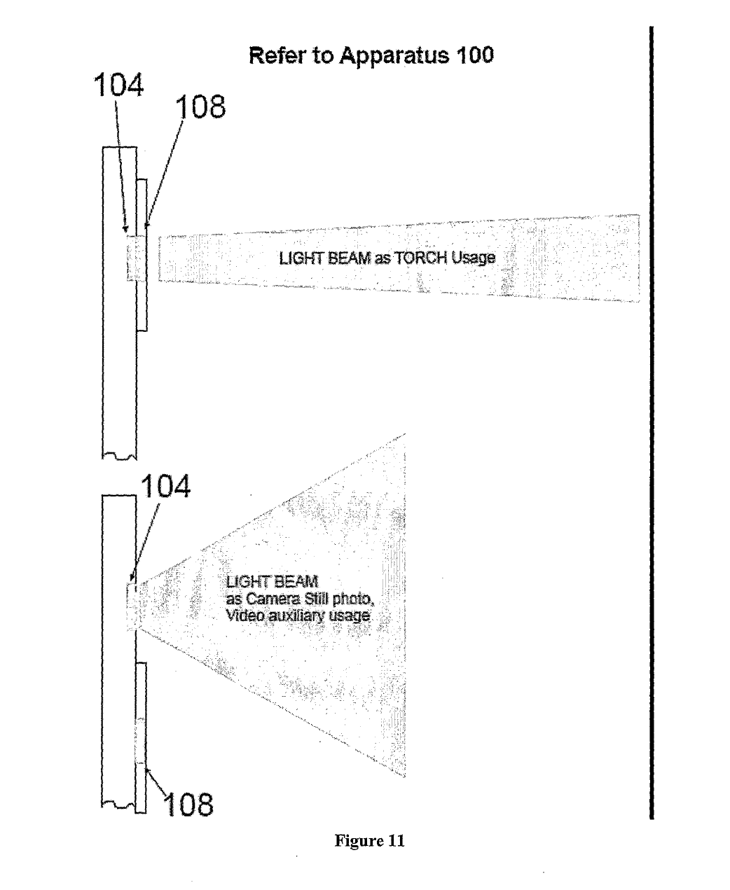

FIG. 11 shows light-output patterns of the first apparatus 100. The top image shows the apparatus 100 in the closed configuration, in which light is emitted from the light-output region 104 through the first optical element 108 in the second light-output configuration. The bottom image shows the apparatus 100 in the open configuration, in which light is emitted from the light-output region 104, but not through the first optical element 108, in the first light-output configuration. The first light-output pattern, which is suitable for use as a flash, has a high power and roughly the same opening angle as the camera lens (not shown in FIG. 11). The second light-output pattern, which is suitable for use as a torch, provides the maximum continuous intensity of light source and has a narrower angle than the flash.

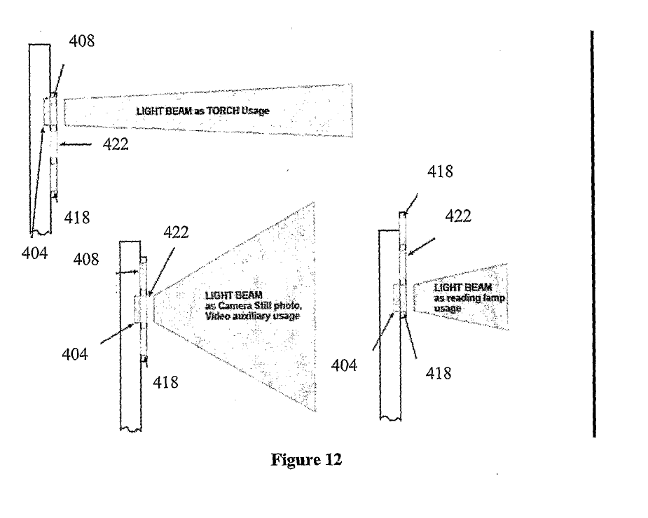

FIG. 12 shows a fourth apparatus 400 and light-output patterns of the fourth apparatus 400. The apparatus 400 has a first configuration shown in the upper left-hand image of FIG. 12, in which configuration a first optical element 408 on the moving part 406 is aligned with the light-output region 404. The first optical element 408 adapts the light-output pattern for use of the apparatus 400 as a torch. The apparatus 400 has a second configuration shown in the lower left-hand image of FIG. 12, in which configuration a gap 422 in the moving part 406 is aligned with the light-output region 404. The light-output pattern emitting from the light-output region 404 is suitable for use as a flash for a camera device. The apparatus 400 has a third configuration shown in the lower right-hand image of FIG. 12, in which configuration a second optical element 418 on the moving part is aligned with the light-output region 404. The second optical element 418 adapts the light-output pattern for use of the apparatus 400 as a reading lamp. When used as a flash the light output has a high power and roughly the same opening angle as the camera lens (not shown). When used as a torch the light output is of maximum continuous intensity and has a narrower angle than the flash. When used as a reading lamp the light output is diffused to give evenly distributed illumination and has a wider angle, and could be of lower intensity than, the torch.

In a variant to the embodiments described, the light guide may be arranged to take light output from a display backlight. The light may be guided to a macro ring.

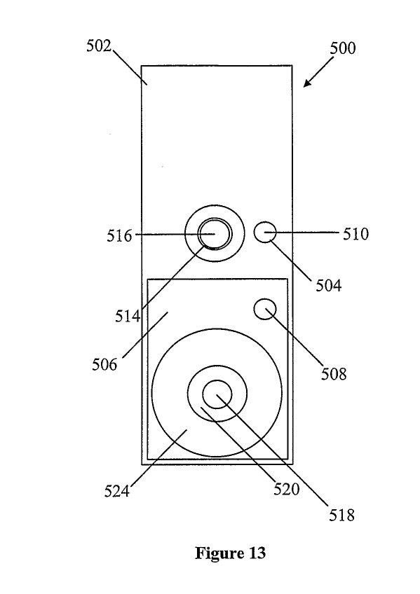

FIGS. 13 to 15 shows a fifth apparatus 500 respectively in a first configuration, a second configuration, and a third configuration. The body 502 comprises a light-output element 510 positioned at a light-output region 504, and a lens 516 positioned at a light-input region 514. The apparatus 500 comprises a moving part 506 which has a first optical element 508, and a macro lens 518 surrounded by dark matter 520 and by a second optical element 524.

In the first configuration, shown in FIG. 13, the lens 516 and light-output element 510 are revealed.

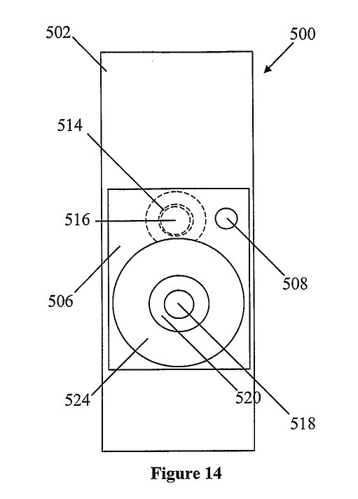

In the second configuration, shown in FIG. 14, the moving part 506 is moved relative to the first configuration such that the first optical element 508 overlies the light-output element 510. The lens 516 is obscured by the moving part 506. The first optical element 508 adapts the light-output pattern of the light-output element 510 for use of the light-output element 510 as a torch.

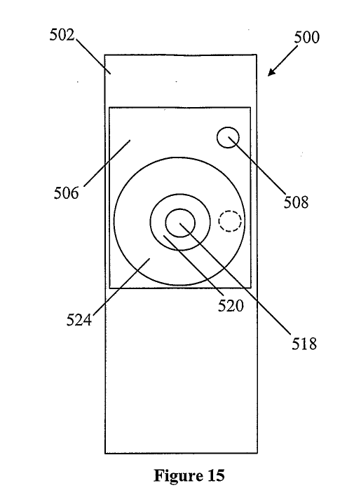

In the third configuration, shown in FIG. 15, the macro lens 518 overlies the lens 516, and the second optical element 524 overlies the light-output element 510. The second optical element 524 adapts the light-output pattern of the light-output element 510 for use of the light-output element 510 in macro photography, by diffusing and/or increasing a beam width of the light output by the light-output element 510.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-27. (canceled)

28. An apparatus for an electronic device, the apparatus comprising
a light-input region,
a light-output region and
a movable part, the apparatus configured such that the movable part is slidably movable between a first position and a second position with respect to the light-output region, the first position defining an open configuration and the second position defining a closed configuration with respect to the light-output region, the light-output region being positioned to be laterally offset to the light input region in the direction of slidable movement or transverse to the direction of slidable movement of the movable part,
the movable part comprising an optical element which, in the closed configuration, at least partially overlies the light-output region and, in the open configuration, overlies the light-output region to a lesser extent than in the closed configuration, the optical element being configured to alter a pattern of light emitted from the light-output region such that the light is emitted in a first light output pattern in the open configuration and in a second light output pattern in the closed configuration.

29. The apparatus according to claim 28, wherein the optical element is configured to, in the closed configuration, guide light emitted from the light-output region to be output lateral but in a direction substantially parallel to the direction in which the light is emitted from the light output region in the open/closed configuration.

30. The apparatus according to claim 28, wherein the optical element is configured to act as a ring flash in the closed configuration by providing for output of light circumferentially around the light-input region.

31. The apparatus according to claim 28, wherein the movable part comprises a second optical element configured such that it lies in an offset arrangement with the light-input region in the open configuration and completely overlies the light-input region in the closed configuration.

32. The apparatus of claim 31, wherein the optical element is configured to surround the second optical element to diffuse light emitted by the light-output region.

33. The apparatus according to claim 31, wherein the second optical element comprises a macro lens.

34. The apparatus according to claim 28, wherein the optical element is a lens or a macro lens.

35. The apparatus according to claim 28, comprising a light-output element for an image sensor, and wherein the apparatus is configured such that the light-output element can emit light from the light-output region when the light output element is activated to emit light.

36. The apparatus of claim 35, wherein the light-output element is configured to act as a flash for image capture by the image sensor when the apparatus is in the open configuration.

37. The apparatus according to claim 35, wherein the light-output element is configured to act as an auxiliary light for video capture by the image sensor when the apparatus is in the open configuration.

38. The apparatus according to claim 28, wherein the optical element is configured to adapt the pattern of light emitted from the light-output region for use in macro photography or for user as one of a torch, or a reading lamp, in the closed configuration.

39. The apparatus of claim 28, wherein the apparatus is configured such that the movable part at least partially reveals the light-input region in the open configuration and at least partially overlies the light-input region in the closed configuration.

40. The apparatus according to claim 28, configured such that a beam width of the second light output pattern is one of narrower or wider than a beam width of the first light output pattern.

41. The apparatus according to claim 31, comprising dark matter positioned between the optical element and the second optical element to prevent flare in a captured image.

42. The apparatus according to claim 28, comprising circuitry configured to control an intensity of the light emitted by the light-output element based on the configuration of the apparatus.

43. A method of operating an apparatus for an electronic device, the apparatus comprising a light-input region, a light-output, and a movable part, the apparatus configured such that the movable part is slidably movable between a first position and a second position with respect to the light-output region, the first position defining an open configuration and the second position defining a closed configuration with respect to the light-output region, the light-output region being positioned to be laterally offset to the light input region in the direction of slidable movement or transverse to the direction of slidable movement of the movable part, the movable part comprising an optical element which, in the closed configuration, at least partially overlies the light-output region and, in the open configuration, overlies the light-output region to a lesser extent than in the closed configuration, the optical element being configured to alter a pattern of light emitted from the light-output region such that the light is emitted in a first light output pattern in the open configuration and in a second light output pattern in the closed configuration, the method comprising:
moving the slidably movable part to cause the optical element to guide light through itself and alter a pattern of light emitting from the light-output region such that the light is emitted in a first light output pattern in the open configuration and in a second light output pattern in the closed configuration.

44. An apparatus for an electronic device, the apparatus comprising
means for allowing light input, means for allowing light output, and means for moving between configurations, said means for moving being slidably movable between a first position and a second position with respect to the means for allowing light output, the first position defining an open configuration and the second position defining a closed configuration with respect to the means for allowing light output, the means for allowing light output being positioned to be laterally offset to the means for allowing light input in the direction of slidable movement or transverse to the direction of slidable movement of the means for moving;
the means for moving between configurations comprising means for altering a light-output pattern configured such that which, in the closed configuration, at least partially overlies the means for allowing light output and, in the open configuration, the means for altering a light-output pattern overlies the means for allowing light output to a lesser extent than in the closed configuration,
and wherein the means for altering a light-output pattern is configured to alter a pattern of light emitted from the means for allowing light output such that the light is emitted in a first light output pattern in the open configuration and in a second light output pattern in the closed configuration.

45. A computer program for the apparatus of claim 1, the computer program configured to control the intensity of the light emitted by the light-output element based on the configuration of the apparatus.

46. An apparatus according to claim 1, wherein the optical element is configured to, in the closed configuration, guide light through itself, the light emitted from the laterally offset light-output region being guided to.
